(19) United States
(12) Patent Application Publication
(10) Pub. No.: US 2005/0108098 A1
(43) Pub. Date: May 19, 2005

(54) NETWORK CONTROLLED RETAIL SHELF DISPLAY RECEIVER SYSTEM AND METHOD

(75) Inventors: Majid A. Syed, Princeton, NJ (US); Masoud Qurashi, Ocean Twp., NJ (US)

Correspondence Address: Majid A. Syed, 97 York Dr., Princeton, NJ, 08540, US

(73) Assignees: Majid A. Syed, Princeton, NJ (US); Masoud Qurashi, Ocean Twp., NJ (US)

(21) Appl. No.: 10/707,001

(22) Filed: Nov. 13, 2003

(51) Int. Cl. G06F 17/60

(52) U.S. Cl. 705/16

(57) ABSTRACT

Pluralarity of network controlled retail display receiver is attached to the shelf carrying items whose information such as price and other attributes need to be displayed. The display receiver wakes up to see the information change bit indicator and its addresssed group. If detected, receiver captures the packet, decodes it and rrefresh its man machine interface. The receiver gets command from the controller either placed in the store or through digital terrestrial/satellite broadcast networks. The invention allows consistant management of similar items information placed in retail stores of same franchise, geographically apart.

### CROSS REFERENCE TO RELATED APPLICATIONS

Not applicable

### FEDERAL RESEARCH STATEMENT

Not applicable

### BACKGROUND OF INVENTION

Information management system for Retail Store using telecommunication systems.

### SUMMARY OF INVENTION

A small data receiver with display is tightly attached with the shelf. The data receiver has a unique equipment serial number and receive information to be displayed over a wireless access interface. The controller broadcast information relating to the items placed on the shelf. The addressed data receiver, captures the information, decodes it and sends it to the display unit. The data receiver has a sleep feature and wakes up only when instructed by the controller. The controller which is local to said receiver may be connected with the network controller for a larger footprint display refresh of same retail shelf items.

### BRIEF DESCRIPTION OF DRAWINGS

FIG. 1 shows main functional diagram of small data display receiver having various forms of wireless access interface (a) ISM RF, (b) Digital FM/AM Radio Broadcast (c) Satellite RF radio broadcast. FIG. 2 shows architecture of local foot print end-2-end retail shelf information automation system. FIG. 3 shows architecture for end-2-end automation system with local controller for regional and national foot print. FIG. 4 shows end-2-end automation system, where a controller communicates with the retail shelf display receiver over emerging terrestrial digital broadcast radio networks. FIG. 5 shows end-2-end automation system, where a controller communicates with retail display shelf receiver over Satellite broadcast digital radio networks. FIG. 6 shows an optimized protocol structure allowing battery save and filtering of information for retail shelf display to the receiver.

### DETAILED DESCRIPTION

PRIOR ART An addressable retail shelf display receivers attached to the shelf of a retail store, waking up to sniff its address and if matched, parse the payload for display to man machine interface is not found in the literature. In patent application No. 20020061769, mobile handset is used as a display receiver where a nearby transmitting station pushes the information relevant to user location. This differs from our invention in the sense that the handset must be on, the handset must be configured to accept such solicitations, and subscriber must not have put a filter for pushed solicitation. In patent application No. 20020012406, talks about a digital receiver, which facilitates storing of repetitive broadcast information where a one-period amount of data is separated from a data, broadcast signal. The one-period amount of data is stored in a data storage device, thereby simplifying the construction of the data storage device. Again this invention suggest that for every reception, a comparison need to be triggered requiring receiver to be always on and always listening. Also if the user of the device can do pick and choose filter initialization then a vendor broadcast information may never make it to the display (as it gets filtered at lower layers of processing). This invention differs from ours in the sense that there is no storage and no retrieval. First we capture only targeted information, then display it. The information remained as is till gets a new refresh from the controller. In patent application No. 20020120495, talks about Retail systems and methods employing a product shelf display to provide purchase incentives and present various forms of electronic coupon system and method. The object of the present invention is to provide an improved system and method for issuing discounts and therefore differs from the proposed network controlled display display system, where some visual alert mechanism is introduced for making customer get attracted leading to purchase incentive and may be referred as coupon less method. In issued U.S. Pat. No. 6,354,495, U.S. Pat. No. 6,112,988 and U.S. Pat. No. 6,173,891 all from same assignee is an electronic system for creating, dispensing, and redeeming electronic discount coupons in a store. The system includes a “smart card”, product stations adjacent to selected products in the store, and a checkout station in the checkout area. To create an electronic coupon, the customer inserts the card into the product station adjacent to a product the customer wishes to purchase, and the product station then writes an electronic coupon onto the card. The customer thus shops throughout the store collecting electronic coupons for products of interest. Upon completion of shopping, the customer redeems the electronic coupons at the checkout area, by inserting the card into the checkout station. During checkout, when UPC data snatches data stored on the card, the customer is credited with the value of the corresponding coupon. Periodically, the electronic coupon data is transferred to a remote-clearing house. It is therefore an intent of our invention is to have an automation system which can perform management of price display in particular and management of other information in general for local, regional and national retail foot print with reference to consistency, ease of use and saving manual hourly cost.

### DESCRIPTION OF THE PREFERRED EMBODIMENTS

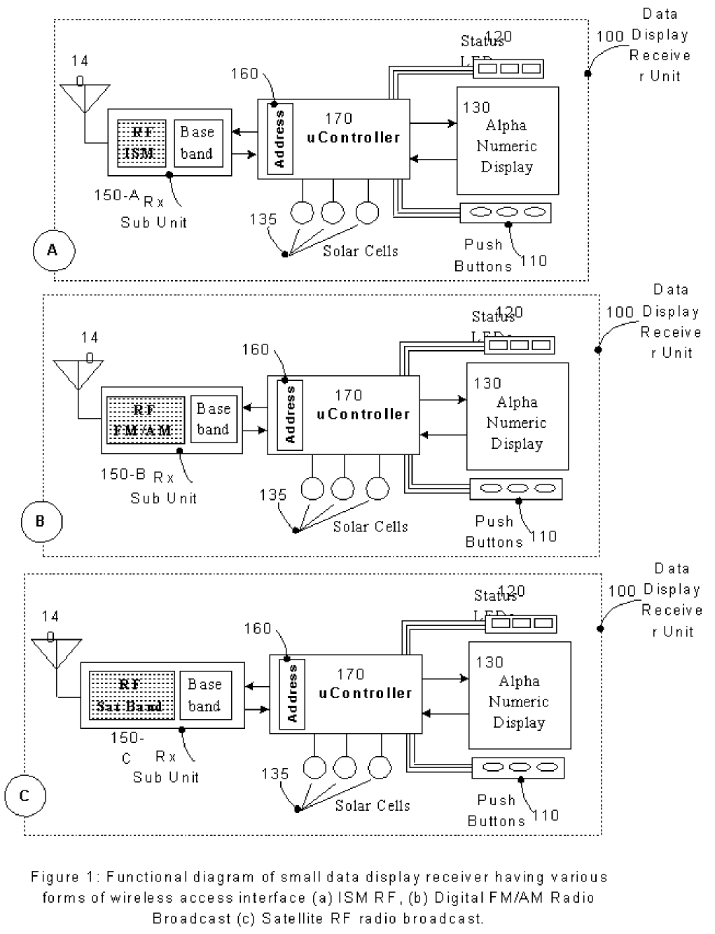

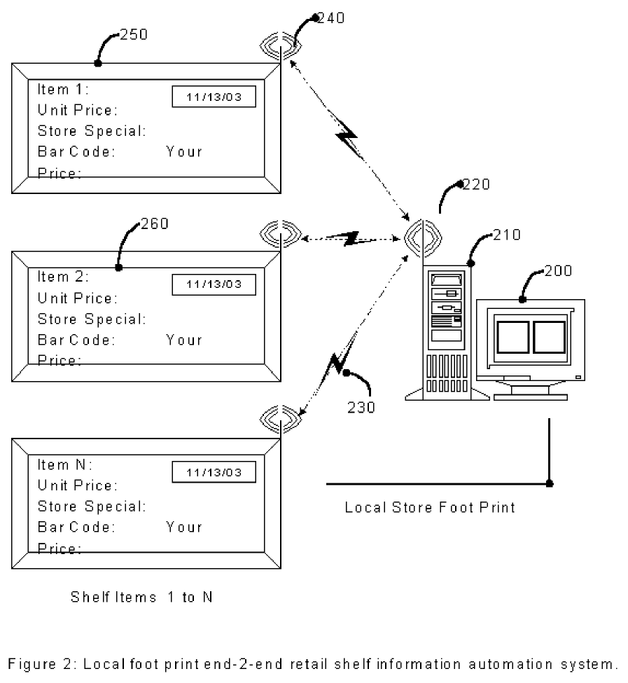

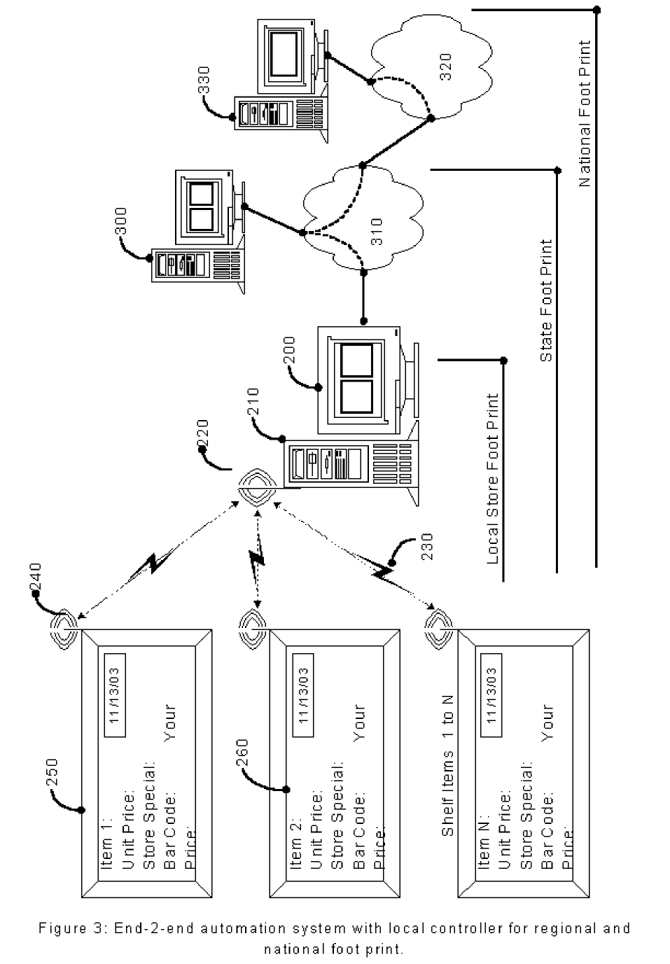

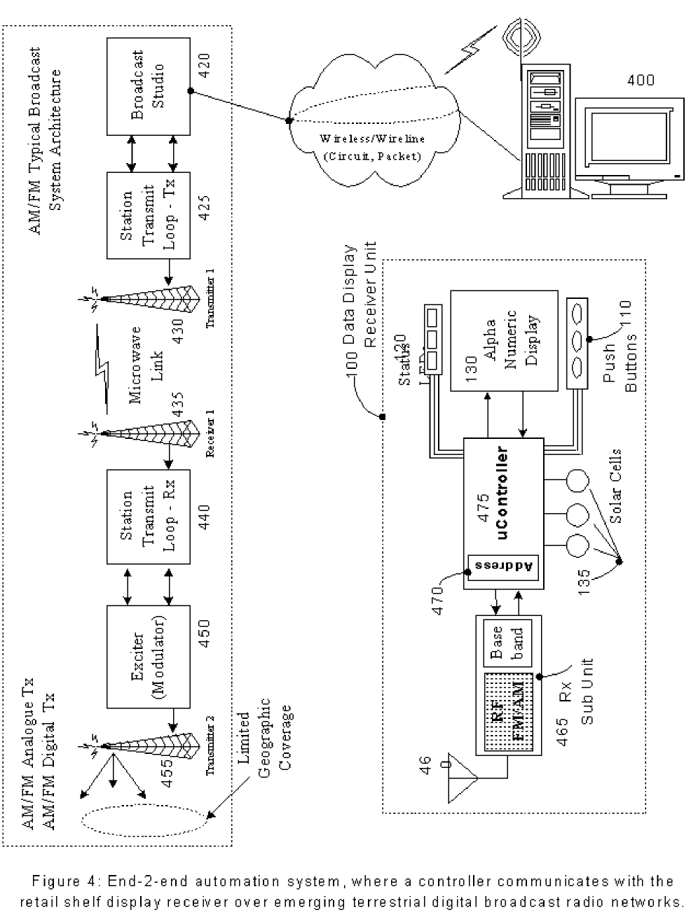

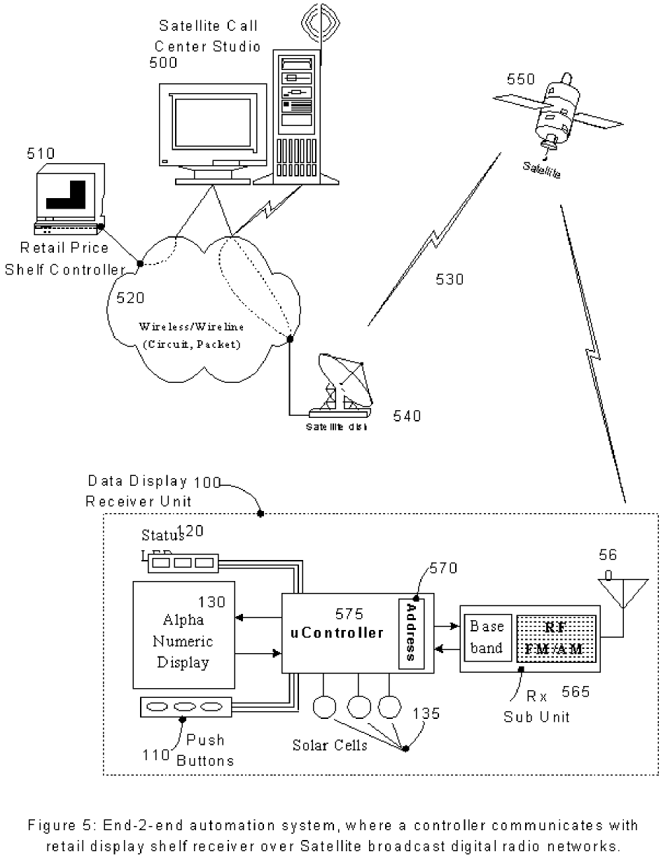

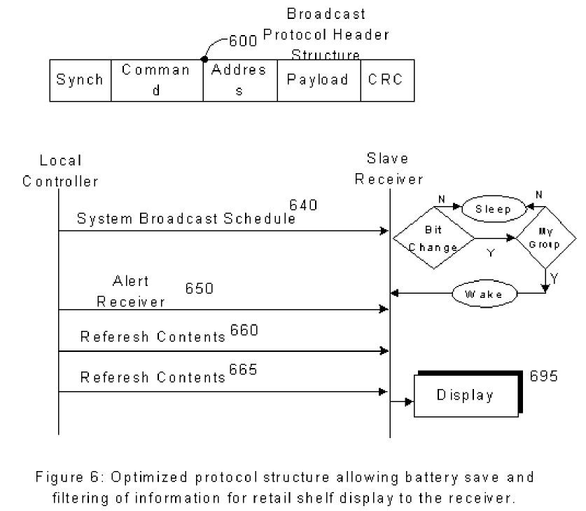

Generally, the retail stores e.g. super markets have many items. To these items, attributes such as unit price, bar code and other information are associated. The price of these items is an important factor to the consumer. To attract consumption, the store manager may need to change the price of these items weekly or as per need of nearby competition. One method is to manually place a sticker to each item, reflecting the change. Doing so may cause inconsistent price of the same item in the nearby same super store. Therefore change has to be made over there also. The issue may thus get compounded as the store foot prints increases. For example, say SAM's club wants to change the price of a certain item. Therefore all SAMS stores must implement that change. Manually placing a price change sticker is therefore very time consuming and add to man hour cost. We propose network controlled display automation system. The system allows a great flexibility of price/information management and is open to other add-on features. The receiver is tightly attached to the shelf of a retail shelf. We take an existing state-of-art wireless receiver which is well known in its interference, coverage, ease of implementation and cost characteristic. According to the surrounding environment, there may be a need to pick various forms of such receiver e.g. the retail store may be few hundred square feet or few thousand square feet and may a have a unique interference profile. Therefore one form of wireless access may not be suitable for the other. Assuming having a desired wireless access interface, the interface communicates with low cost micro controller which display the information on the receiver. The following discuss in detail the present invention. In FIG. 1, we present main functional block components of data display receiver 100. The items which are visible to the user are Push Button 110, LEDs 120, Alpha Numeric Display 130, optionally solar cell 135 for power requirement and or antenna 140. The push button man machine interface is used for various functions such as testing the unit, activating the unit, reading the stored address of the unit or editing the store address of the unit etc. Similarly, man machine interface for LEDs is used to give a visual indication to assist the viewer with following e.g. (a) A blinking red means the receiver is locked with the local controller and is getting the information refreshed. (b) A solid red means cannot determine synch with the local controller. (c) A solid green means no change in displayed information. (d) A green blink means special item on sale etc. The alphanumeric is a passive device which takes its contents from the micro controller 170. As per stored boot protocol micro wakes up every TBD time and instructs the receiver 150-A over ISM to capture the broadcast message. ISM stands for Industrial, Scientific, and Medical bands and is authorized to be used for wireless LAN's. The bands are 902 Mhz, 2.4 Ghz and 5.7 Ghz The baseband module provides captured bits to the address decoder 160 to decode the address. Upon address match, the information is decoded and sent to the alphanumeric display. In FIG. 6, we discuss in detail the end-2-end protocol for battery save and information decoding. Another variant of the receiver module is 150-B. The digital broadcast terrestrial radio networks have capability to provide broadcast information which can be captured by receiver 150-B keeping rest of the system transparent. As will be more explained in FIG. 4. Another variant of the receiver module is 150-C. The digital broadcast radio satellite networks have capability to provide broadcast information which can be captured by receiver 150-B keeping rest of the system transparent. As will be explained more in FIG. 5. In FIG. 2, we define a controller having its access to only data display receiver located within the store foot print. The controller has an inventory of store items and their placement on shelf row. Using this information, the local controller tags display receiver address with the shelf item attributes. This process is done for the desired number of unique shelf items. Now, if the store manager desire to change the information of the shelf item say price, using graphical user interface 200 it instructs the local controller 210 to broadcast the information using antenna 220. The transmission link being ISM-RF 230, and assuming the receiver is powered, it listens to the broadcast message 240 and pass on to internal processing 250 for activity bit monitoring followed by address decode and process for CRC to be then displayed at 260. In FIG. 3, the local controller is connected to network controller 300 over public/private switched wireless, wireline, CATV or composite networks. The local controller and network controller communicates over well known duplex protocols. The shelf price and other information management foot print is therefore increased to regional keeping every thing transparent with respect to receivers. Similarly for national foot print, another controller 330 communicates with 310 over 320 over public/private switched wireless, wireline, CATV or composite networks. The shelf price and other information management foot print is therefore increased to national keeping every thing transparent with respect to receivers. That is receivers does not need to know if the refresh is from local or regional or national controller. In FIG. 4 regional foot print can be achieved more effectively by having a system over terrestrial FM/AM digital radio broadcast. As shown, the receiver module antenna 460 tunes of local FM/AM broadcast by having a digital FM/AM tuner 465. The regional change controller 400 communicates with Broadcast Station Studio420, which gives it data to Station Transmit Loop STL-Tx 425 which communicates with microwave transmitter 430 and sends the information to receiver 435 located at a higher altitude over microwave link, handing over the information to Station Transmit Loop Rx 440 which gives it to exciter 445 to power transmitter 450 for larger foot print. The information is therefore captured by display receiver if tuned. Because the coverage foot print depends on the watage of transmitted power therefore much larger area can be covered most cost effectively with some trade-off. In FIG. 5 national foot print can be achieved more effectively by having a system over satellite digital radio broadcast. As shown, the receiver module antenna 560 tunes of satellite digital satellite tuner 560. The national change controller 510 communicates over Circuit/Packet wireless, wireline, CATV or composite duplex communication network 520 with Satellite call center 530 which uplinks the data using 540 over satellite RF band 545 to satellite 550 which down beams to all the receivers. Because the coverage foot print therefore national foot print display refresh can be achieved most cost effectively with some trade-off. Now we discuss various variant of information transmission protocol to the receiver. In its simplest form, a scale down XML decoder is added in the receiver and using MMI external buttons as said 110, the capture field is initialized. This means if the receiver is to be placed at shelf containing Milk, the receiver is initialized with Type=Milk, sub type being 2%. The controller making use of available bandwidth link sends a broadcast composite message with many types. The receiver which is placed at the Milk Shelf filters every thing except Type=milk and as such passes the information to the display unit to display information related to Milk such as price. This method though simple, requires the receiver to be powered on all the time. Protocol like this is a drain on the battery and as such may require battery maintenance frequently. Also, because the information does not need to be changed therefore, it is not wise to keep the receiver always on. A power save protocol is therefore defined next. In FIG. 6, we discuss basic fundamental protocol followed by the controller and understood by the receiver. Each new capture begins with a synch pattern, followed by command, followed by address of the device, followed by payload (length, info element) and terminates with a CRC. The local controller sends sych pattern every TBD seconds. Following synch pattern is a command message. In the command message, the local controller indicates a bit indicator identifying which group of receivers should remain active and others to turn off, e.g. only dairy products and paper products be remain active. Following command message, is a multi group payload (depending upon link bandwidth. Therefore, if the information is related to dairy group, the receiver attached to the say milk shelf captures the information, validates using CRC if healthy proceeds for display. If CRC is bad, received information is discarded and refresh is not initiated. In the next synch, each receivers wakes up and read broadcast change bit indicator. If no change from previous broadcast, all receivers can go to sleep. Another variant of the protocol is to have a unique address and as such relieves the receiver from some type of wXML. The difference being one is software controlled the other is hard coded and does not require any WXML decoder, therefore ends in low cost. A unique address is assigned to the receiver either at factory burned later retrievable by using said 110 or can be soft programmed by using said 110 or soft programmed over the air by said controller 200. As said earlier, the boot code in the receiver, wakes the receiver every TBD seconds to get in synch with the broadcast message from local controller. Once synched, the baseband monitors activity bit in the command message. If no refresh is desired then, then synch message is followed by a null flag. If set, discovers new information and reads the address to determine if intended activity is for the its pre-initialized group. If so, it looks if addressed to him. If so, the microcontroller determines if the received information is free of error i.e. validates it using CRC. Upon so, the received information is converted into ASCII text, which is then displayed on the display unit. Because of simplex link between controller(200, 330,330, 400 and 530) and the said receiver, the local controller may perform couple of repeat to attempt that error free information has been received by the desired data display receiver.

1. An addressable receiver display unit mounted on retail shelf comprising: a system to prevent inadvertent removal of said portable display receiver units from the shelf, having a network access interface, a microntroller, a display man machine interface for communicating with the unit and a software program to decode input.

2. For claim 1, the access interface is either over ISM RF or either over terrestrial digital commercial FM/AM radio broadcast or over Satellite broadcast network.

3. An antenna according to claim 2 which is shielded to prevent interference with other wireless systems supplying that detected signal to baseband processor.

4. For claim 1, a controller having a software program to decode the captured message, filter the message and take appropriate action of discard, accept, process and send to display.

5. For claim 1, man machine interface is a display unit to display multimedia info.

6. For claim 1, additional MMI of plurality of blinking LEDs to attract viewer for special promotion.

7. For claim 1, man machine interface having means to key in external input via few buttons.

8. For claim 1, display receiver having means for providing an address either hard code (factory burned) retrievable using said 4.

9. A stand-alone local controller unit comprising means for transmitting signals to said portable receiver units for local foot print.

10. For claim 9, local controller having a transmitter antenna capable of propagating said signal to the far end of the all the local defined display receiver.

11. For claim 9, address allocation via said local controller 9 assigning the said address to said receiver 1 using man machine input method said 7.

12. For claim 9, alternate method of entering pre-burned address to said local controller.

13. A local controller unit according to claim 8 which provides means to test display receiver units.

14. For claim 1, means to test said display receiver comprising a push-to-test button.

15. For claim 9, a bit indicator indicating change in broadcast status, allowing receivers of claim 1 to remain sleep if no change in the broadcast message.

16. For claim 9, controller having an optimized scheduling scheme to schedule, receivers to wake up and sleep those which do not detect there address group.

17. A communications system for providing information to a regional foot print display receiver, comprising: a plurality of local controllers positioned in different locations of a designated area and configured for receiving information from a master network controller; a communications unit destined for transmission of information to each of the local controller.

18. The communications system of claim 17, wherein the communications unit is a central processing unit, which is connected to the local controllers over circuit/packet or wireless, wired CATV or composite network infrastructure.

19. A communications system comprising over terrestrial digital broadcast FM/AM radio for providing information to a regional foot print display receiver, comprising an information source communicating with the broadcast station system studio over switched circuit/packet network and broadcast station system transmitting the information to receivers of its coverage foot print and display receivers equipped with digital FM/AM decoder said claim 2 for decoding the broadcasted information, filtering and displaying to the display unit.

20. A communications system comprising over satellite digital broadcast FM/AM radio for providing information to a regional and national foot print display receiver, comprising an information source communicating with the satellite broadcast station system studio over switched circuit/packet network and satellite broadcast station system uplink to satellite, then down link transmitting the information to receivers of its coverage foot print and display receivers equipped with satellite receiver decoder said claim 2 for decoding the broadcasted information, filtering and displaying to the display unit.
